(19) United States
(12) Patent Application Publication
(10) Pub. No.: US 2017/0251514 A1
(43) Pub. Date: Aug. 31, 2017

(54) SESSION TRANSFER BY TUNNEL ENDPOINT IDENTIFIER RENUMBERING

(71) Applicant: NOKIA SOLUTIONS AND NETWORKS OY, Espoo (FI)

(72) Inventors: Jani Olavi SODERLUND, Vantaa (FI); Tommy Johannes LINDGREN, Espoo (FI); Sumanta SAHA, Espoo (FI); Niko Markus SAVOLAINEN, Kerava (FI); Klaus HOFFMANN, Munich (DE)

(73) Assignee: NOKIA SOLUTIONS AND NETWORKS OY, Espoo (FI)

(21) Appl. No.: 15/516,177

(22) PCT Filed: Oct. 1, 2014
(86) PCT No.: PCT/EP2014/071018

§ 371 Date: Mar. 31, 2017

(51) Int. Cl. H04W 76/04; H04L 29/12; H04L 29/08

(52) U.S. Cl. CPC H04W 76/041; H04L 67/148; H04L 61/2007; H04W 84/042

(57) ABSTRACT

The present invention addresses method, apparatus and computer program product for enabling session transfer by Tunnel Endpoint Identifier renumbering in GPRS Tunneling Protocol peer. A new Tunnel Endpoint Identifier value is allocated for the existing session, information about relocating the existing session including the new Tunnel Endpoint Identifier value for the existing session is communicated to the peer network elements of the relocated resource, tunnel endpoint change procedure towards counterpart network elements is performed, and the existing session is removed from the original resource and processing is continued in the relocated resource.

### FIELD OF THE INVENTION

The present invention generally relates to wired and wireless communication networks, and more specifically relates to a method, apparatus and computer program product for enabling Session transfer by Tunnel Endpoint Identifier TEID renumbering in GPRS Tunneling Protocol GTP peer.

### BACKGROUND

Mobile data transmission and data services are constantly making progress, wherein such services provide various communication services, such as voice, video, packet data, messaging, broadcast, etc. In recent years, Long Term Evolution LTE™ has been specified, which uses the Evolved Universal Terrestrial Radio Access Network E-UTRAN as radio communication architecture according to 3GPP specification.

Generally, in such mobile network, the user sessions are established as tunnels between the Mobile Terminals (MT) and Gateways (GW). Due to cellular network architecture, Gateways are the aggregation points for the user sessions, providing the anchor towards the services in the Internet or operator service network. In 3G the gateway is the Gateway GPRS Support Node GGSN element, and in LTE the System Architecture Evolution Gateway SAE-GW element.

FIG. 1 schematically depicts a wireless network according to current 3GPP specifications. In particular, a Mobile Terminal establishes a session e.g. in the Internet, Service Network, or the like, via a 3GPP Domain. In 3G the Domain comprises base stations NodeB, Radio Network Controllers RNC, Serving GPRS Support Nodes SGSN, and the gateway is configured as a GGSN. According to e.g. LTE specifications, the 3GPP comprises base stations eNodeB and a LTE-Gateway, wherein a Mobility Management Entity MME additionally is provided.

The number of gateway elements in an operator network differs depending on the size of the operator's subscriber base, redundancy requirements, site strategy, element capacity, and so forth. As the market demands higher aggregation capabilities, only few elements are expected to stay in a network. The user sessions are distributed across the Gateway elements.

Current gateway elements are based on dedicated hardware and thus gateways are typically overdimensioned to address near-term traffic and session growth. Typically then additional gateways are deployed as traffic volume and signalling demands grow.

In the future also mobile gateway is likely implemented as a software only application product running over generic hardware that may be virtualized. This allows fast scaling of the systems, and also allows operator to create new gateways quickly by using cloud technologies.

FIG. 2 shows an example of a virtual gateway running in a cloud using virtual machines over generic hardware. Thereby, a cloud management controls a host CPU cluster which comprises a plurality of Virtual Machines VM dedicated to specific gateway and management functions.

Currently, according to 3GPP standards, it is only possible to change the GTP Tunnel Endpoint Identifier for an established session during the GTP-C bearer modify request/response procedure. It is noted that the functionality is restricted to the user plane. However the usage of the Modify bearer response limits the applicability to the case for an IDLE state UE initiated TAU/RAU procedure indicated in the Modify bearer request. In that case the TEID(/Session) of course might be transferred to another VM without loss of continuity of the service, but only in those circumstances. This makes it difficult to move sessions e.g. from a gateway to another, or to move a session inside a gateway to another HW resource. Scaling down GW VMs in a cloud environment requires moving sessions from torn down VM to remaining VMs. Also dynamic load balancing between GW instances is not possible without TEID change possibility.

Since it is currently only possible to change U-TEID in runtime during the GTP-C bearer modify request/response procedure, it is very difficult to re-balance sessions inside a system as basically host based entries are needed in internal load balancing solution, wherein each sessions has a TEID entry leading into millions of entries, which is technically challenging. Current gateways do neither provide sufficient support for re-balancing nor for moving sessions internally from one (hardware) resource to another.

In the technological field of the present invention, the US patent application 2013-0070711 describes controlling of S-GW's permission to modify TEID or IP address. Further, the document 3GPP TS 29.274 discloses the current GTPv2 specification.

Hence, there is the demand for improving a session transfer so as to enable re-balancing and moving sessions from one resource to another.

### SUMMARY OF THE INVENTION

Therefore, in order to overcome the drawbacks of the prior art, it is an object underlying the present invention to provide a session transfer by TEID renumbering.

In particular, it is an object of the present invention to provide a method, apparatus and computer program product for enabling session transfer by TEID renumbering in GTP peer. That is, the present invention proposes independent TEID/IP address modification decision for any GTP peer for scaling and load balancing purposes.

According to a first aspect of the present invention, there is provided a method for relocating an existing session in a communication system to another resource, comprising allocating a new Tunnel Endpoint Identifier value for the existing session, communicating information about relocating the existing session including the new Tunnel Endpoint Identifier value for the existing session to the peer network elements of the resource being relocated, performing tunnel endpoint change procedure towards counterpart network elements, and removing the existing session from original resource and continuing processing in the relocated resource.

According to a second aspect of the present invention, there is provided an apparatus, comprising an allocation unit configured to allocate a new Tunnel Endpoint Identifier value for the existing session, a communication unit configured to cause a communication of information about relocating the existing session including the new Tunnel Endpoint Identifier value for the existing session to the peer network elements of the resource being relocated, a changing unit configured to perform a tunnel endpoint change procedure towards counterpart network elements, and a processing unit configured to remove the existing session from original resource and to continue processing in the relocated resource.

According to a third aspect of the present invention, there is provided a computer program product comprising computer-executable components which, when the program is run, are configured to carry out the method according to the first aspect.

Advantageous further developments or modifications of the aforementioned exemplary aspects of the present invention are set out in the dependent claims.

According to certain embodiments of the present invention, a new tunnel IP-address for the existing session is allocated, and the new tunnel IP-address is added to the information.

Further, according to certain embodiments of the present invention, the relocation is performed during user and/or signaling activity.

Further, according to certain embodiments of the present invention, the session transfer procedure is independently activated for either the user plane or the control plane or both.

Further, according to certain embodiments of the present invention, the resources can be realized as at least one of Virtual Machines, hardware resource and physical server.

Further, according to certain embodiments of the present invention, in case of any of glare, contention and crossing over of signaling messages, the peer rejects the request for session relocation by returning back a rejection indication, wherein the indication may comprise a time period after which the session relocation can be performed.

According to certain embodiments of the present invention, in case of any of glare, contention and crossing over of signaling messages requesting a session relocation from both sides simultaneously, performing a resolution wherein the session relocation is retried at a later point of time.

Still further, according to certain embodiments of the present invention, the session relocation rate is controlled by the original resource, wherein the session relocation rate may be controlled by using predefined or random timeout between transmission of Update Tunnel requests or by maintaining a transmission window per counterpart network element.

According to certain embodiments of the present invention, a message pair Update Tunnel request and Update Tunnel response is transmitted between the involved GPRS tunnel protocol peer elements for initiating session relocation.

According to certain embodiments of the present invention, the Update Tunnel request message is utilized for Idle sessions and/or non Idle sessions.

According to certain embodiments of the present invention, the peer network elements are from the group comprising Mobility Management Unit, Serving GSN Support Node, Packet Data Network Gateway and Serving Gateway, Gateway GPRS Support Node, Radio Network Controller and evolved NodeB.

Further, according to certain embodiments of the present invention, in sequence delivery via the Sequence Number carried in a GTP-U header for preserving the transmission order of packets is performed.

Still further, according to certain embodiments of the present invention, the original resource buffers messages until it receives an End Marker from the relocated source indicating that all Protocol Data Units are delivered.

### BRIEF DESCRIPTION OF DRAWINGS

For a more complete understanding of example embodiments of the present invention, reference is now made to the following descriptions taken in connection with the accompanying drawings in which:

FIG. 1 schematically shows a Network according to current 3GPP specifications;

FIG. 2 depicts an example of a gateway running in a cloud using virtual machines over generic hardware;

FIG. 3 shows an S-GW example of a single 3GPP address usage in virtualized GW;

FIG. 4 shows TEID usage in different 3GPP interfaces;

FIG. 5 illustrates a method according to certain embodiments of the invention;

FIG. 6 schematically illustrates an apparatus according to certain embodiments of the invention;

FIG. 7 is an example figure about subscriber/session relocation due to cloud optimization according to certain embodiments of the invention;

FIG. 8 shows a GTP-U header according to certain embodiments of the present invention;

FIG. 9 shows S-GW scale-in example sequence flow with session establishment and proposed new signaling according to certain embodiments of the present invention;

FIG. 10 shows a session transfer synchronization (control plane) according to certain embodiments of the present invention; and

FIG. 11 shows a session transfer synchronization (user plane) according to certain embodiments of the present invention;

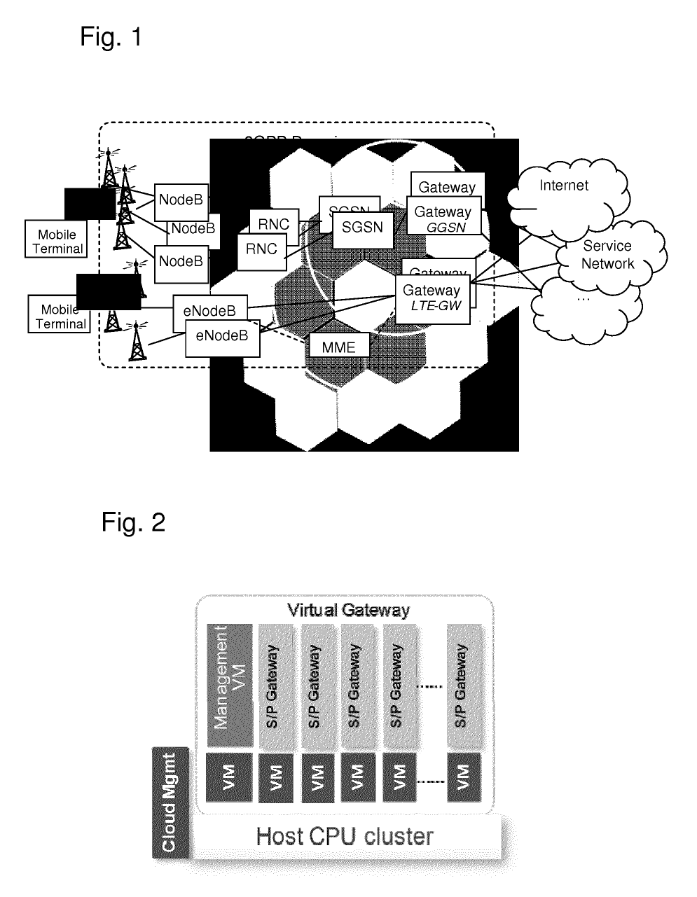

### DESCRIPTION OF EXEMPLARY EMBODIMENTS

Exemplary aspects of the present invention will be described herein below. More specifically, exemplary aspects of the present invention are described hereinafter with reference to particular non-limiting examples and to what are presently considered to be conceivable embodiments of the present invention. A person skilled in the art will appreciate that the invention is by no means limited to these examples, and may be more broadly applied.

It is to be noted that the following description of the present invention and its embodiments mainly refers to specifications being used as non-limiting examples for certain exemplary network configurations and deployments. Namely, the present invention and its embodiments are mainly described in relation to 3GPP specifications being used as non-limiting examples for certain exemplary network configurations and deployments. As such, the description of exemplary embodiments given herein specifically refers to terminology which is directly related thereto. Such terminology is only used in the context of the presented non-limiting examples, and does naturally not limit the invention in any way. Rather, any other network configuration or system deployment, etc. may also be utilized as long as compliant with the features described herein.

Some example versions of the disclosure and embodiments are described with reference to the drawings. In the following, different exemplifying examples will be described using, as an example of a communication network, a cellular wireless communication network, such as an LTE or LTE-Advanced based system. However, it is to be noted that the present invention is not limited to an application using such types of communication system, but is also applicable in other types of communication systems, be it wireless systems, wired systems or systems using a combination thereof.

Hereinafter, various embodiments and implementations of the present invention and its aspects or embodiments are described using several alternatives. It is generally noted that, according to certain needs and constraints, all of the described alternatives may be provided alone or in any conceivable combination (also including combinations of individual features of the various alternatives).

In particular, the following examples versions and embodiments are to be understood only as illustrative examples. Although the specification may refer to “an”, “one”, or “some” example version(s) or embodiment(s) in several locations, this does not necessarily mean that each such reference is to the same example version(s) or embodiment(s), or that the feature only applies to a single example version or embodiment. Single features of different embodiments may also be combined to provide other embodiments. Furthermore, words “comprising” and “including” should be understood as not limiting the described embodiments to consist of only those features that have been mentioned and such example versions and embodiments may also contain also features, structures, units, modules etc. that have not been specifically mentioned.

In general, a telecommunication network comprises plural network elements, such as base stations BS, evolved NodeB's (eNB; i.e. base station in LTE environment), user equipments UE (e.g. mobile phone, smart phone, Computer, etc.), controllers, interfaces, etc, and in particular any equipment used in the provision of a telecommunications service.

A basic system architecture of a communication system where example versions and embodiments are applicable may comprise a commonly known architecture of one or more communication networks comprising a wired or wireless access network subsystem and a core network. Such an architecture may comprise one or more communication network control elements, access network elements, radio access network elements, access service network gateways or base transceiver stations, such as a base station, an access point or an eNB, which control a respective coverage area or cell (macro cell, small cell) and with which one or more communication elements or terminal devices such as a UE or another device having a similar function, such as a modem chipset, a chip, a module etc., which can also be part of a UE or attached as a separate element to a UE, or the like, are capable to communicate via one or more channels for transmitting several types of data. Furthermore, core network elements such as gateway network elements, policy and charging control network elements, mobility management entities, operation and maintenance elements, and the like may be comprised.

The general functions and interconnections of the described elements, which also depend on the actual network type, are known to those skilled in the art and described in corresponding specifications, so that a detailed description thereof is omitted herein. However, it is to be noted that several additional network elements and signaling links may be employed for a communication to or from a base station and a communication network besides those described in detail herein below.

As already indicated above, Aggregating GW services requires multiple processing units (VMs in cloud) per each gateway, i.e. the same IP addresses (e.g. S5 address) are served by many processing units or VMs. GTP protocol identifies sessions and bearers with Tunnel End Point Identifier (TEID) or Fully qualified TEID (F-TEID) which can be used for forwarding signaling and user plane traffic to correct processing unit.

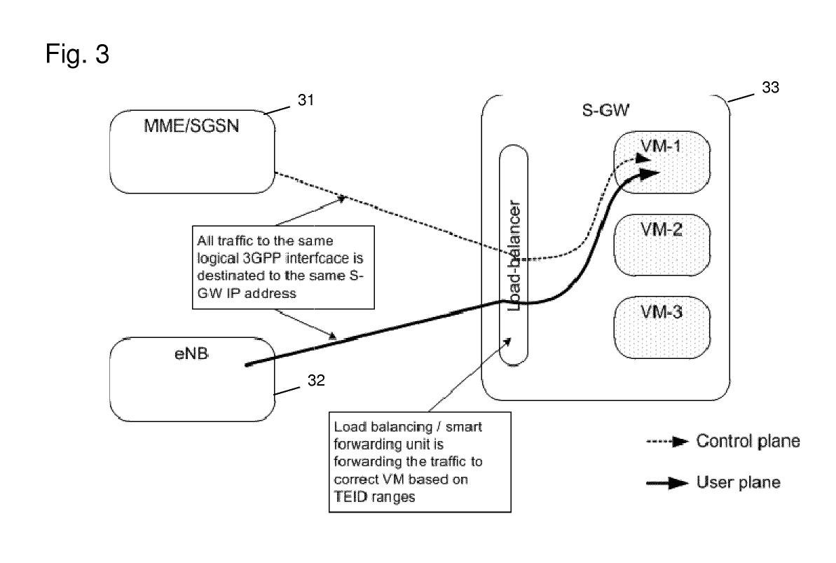

FIG. 3 illustrates the role of the load-balancer in virtualized gateway product. In FIG. 3, a Mobility Management Entity MME (or Serving GSN Support Node SGSN) 31, a base station eNB 32 and a Serving Gateway S-GW 33 are depicted. The S-GW includes a plurality of Virtual Machines VM-1 to VM-3 as well as a load balancer. All traffic to the same logical 3GPP interface is destinated to the same S-GW IP-address (control plane: dashed line; user plane: bold line). The load balancing (smart forwarding) unit forwards the traffic to the correct Virtual Machine based on specific TEID ranges.

In general, TEID is an identification of the subscriber (implicitly only), session or bearer depending on the 3GPP interface. In S4/S11 interface (between S-GW and MME/SGSN) control plane TEID is defined in subscriber level whereas in S5/S8/Gn/Gp interface control plane TEID is defined in session (PDN connection) level. User plane TEID is always defined per bearer.

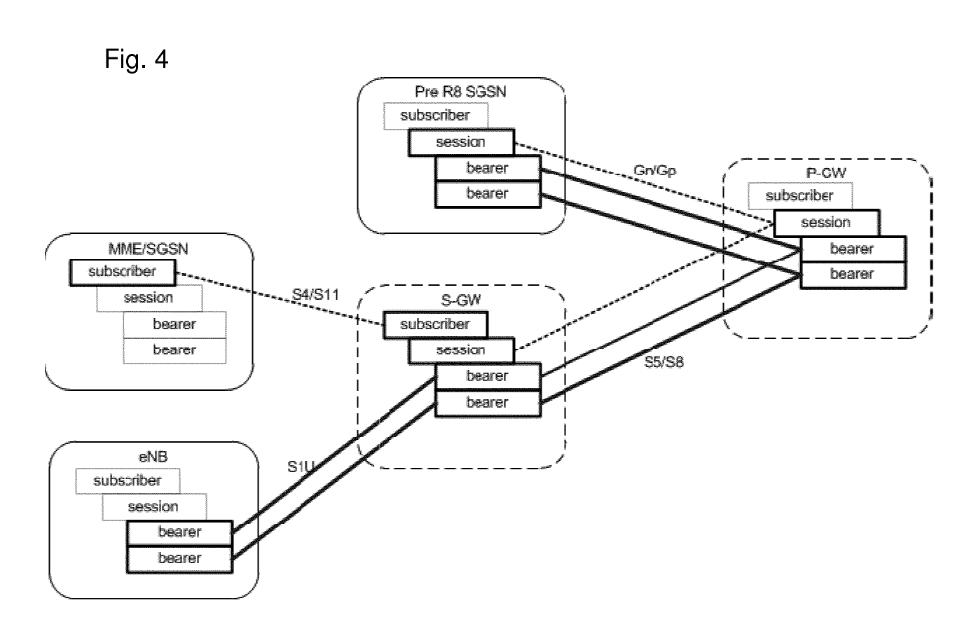

FIG. 4 illustrates such different user and control plane TEID usage, wherein the respective level in which the TEID is defined is depicted by bold boxes.

According to certain embodiments of the present invention, the TEID value, and possibly also the tunnel IP address can be changed on runtime, e.g. for any GTP peer for scaling and load balancing purposes.

For example in case in which a session is moved from one (system internal) resource to another (from a blade to another, or from virtual machine to another), the new resource allocates a new TEID value and possibly also tunnel IP address for the existing session, and communicates this to its peer network elements, such as e.g. MME, SGSN, PGW, SGW.

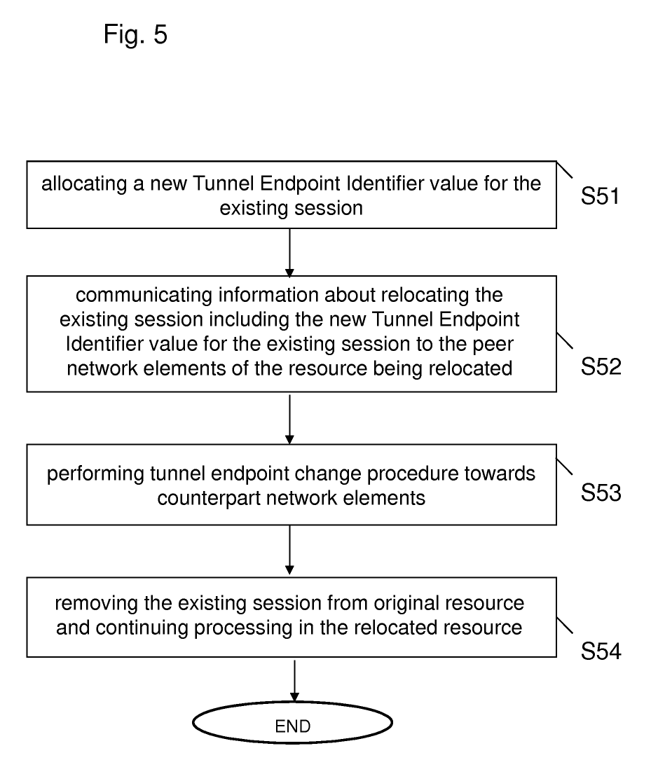

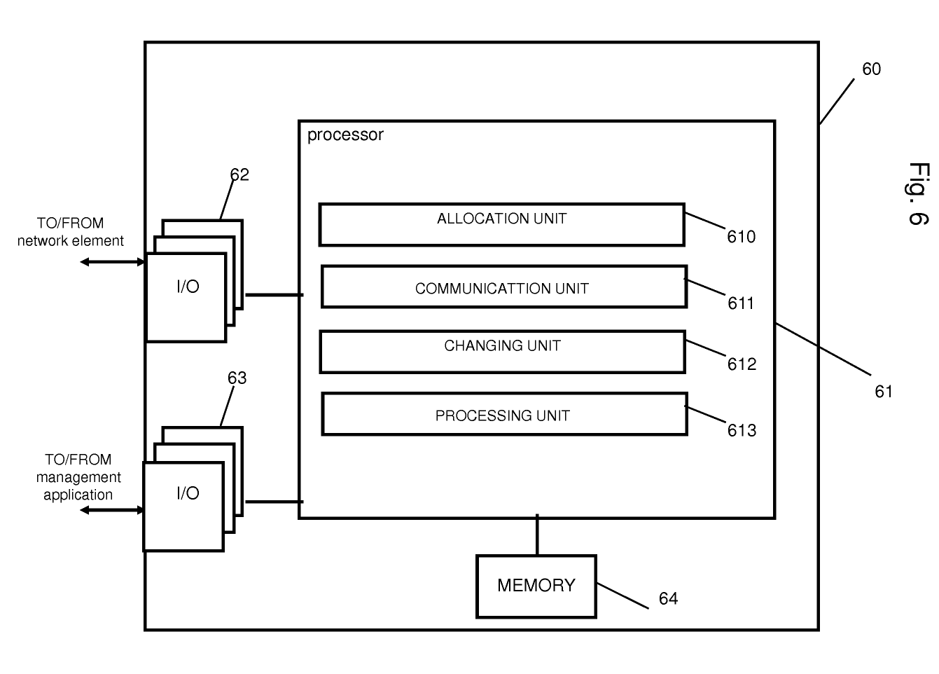

FIG. 5 shows a method according to some example versions of the disclosure.

In Step S51, a new Tunnel Endpoint Identifier value is allocated for an existing session.

Then, in Step S52, information about relocating the existing session including the new Tunnel Endpoint Identifier value for the existing session is communicated to the peer network elements of the relocated resource.

Further, in Step S53, tunnel endpoint change procedure towards counterpart network elements is performed.

Moreover, in Step S54, the existing session is removed from the original resource and processing is continued in the relocated resource.

In FIG. 6, a diagram illustrating a configuration of an element comprised in a (tele-) communication network element of a communication network according to some example versions of the disclosure is shown, which is configured to implement session transfer by Tunnel Endpoint Identifier renumbering as described in connection with some of the example versions of the disclosure. The embodiment may be carried out in or by a network element. It is to be noted that the network element may comprise elements or functions, such as a chipset, a chip, a module etc., which can also be part of a network element or attached as a separate element to a network element, a Virtual Machine, or the like. It should be understood that each block and any combination thereof may be implemented by various means or their combinations, such as hardware, software, firmware, one or more processors and/or circuitry.

The network element 60 shown in FIG. 6 may comprise a processing function, control unit or processor 61, such as a CPU or the like, which is suitable for executing instructions given by programs or the like related to the network element control procedure.

The processor 61 is configured to execute processing related to the above described session transfer by Tunnel Endpoint Identifier renumbering. In particular, the processor 61 comprises a sub-portion 610 as an allocation unit configured to allocate a new Tunnel Endpoint Identifier value for the existing session. The portion 610 may be configured to perform processing according to S51 of FIG. 5. Furthermore, the processor 61 comprises a sub-portion 611 usable as a communication unit configured to cause a communication of information about relocating the existing session including the new Tunnel Endpoint Identifier value for the existing session to the peer network elements of the relocated resource. The portion 611 may be configured to perform processing according to S52 of FIG. 5. Furthermore, the processor 61 comprises a sub-portion 612 usable as a changing unit configured to perform a tunnel endpoint change procedure towards counterpart network elements. The portion 612 may be configured to perform processing according to S53 of FIG. 5. Still further, the processor 61 comprises a sub-portion 613 usable as a processing unit configured to remove the existing session from original resource and to continue processing in the relocated resource. The portion 613 may be configured to perform processing according to S54 of FIG. 5.

Reference signs 62 and 63 denote transceiver or input/output (I/O) units (interfaces) connected to the processor 61. The I/O units 62 may be used for communicating with e.g. network elements. The I/O units 63 may be used for communicating with e.g. a management application. Reference sign 64 denotes a memory usable, for example, for storing data and programs to be executed by the processor 61 and/or as a working storage of the processor 61.

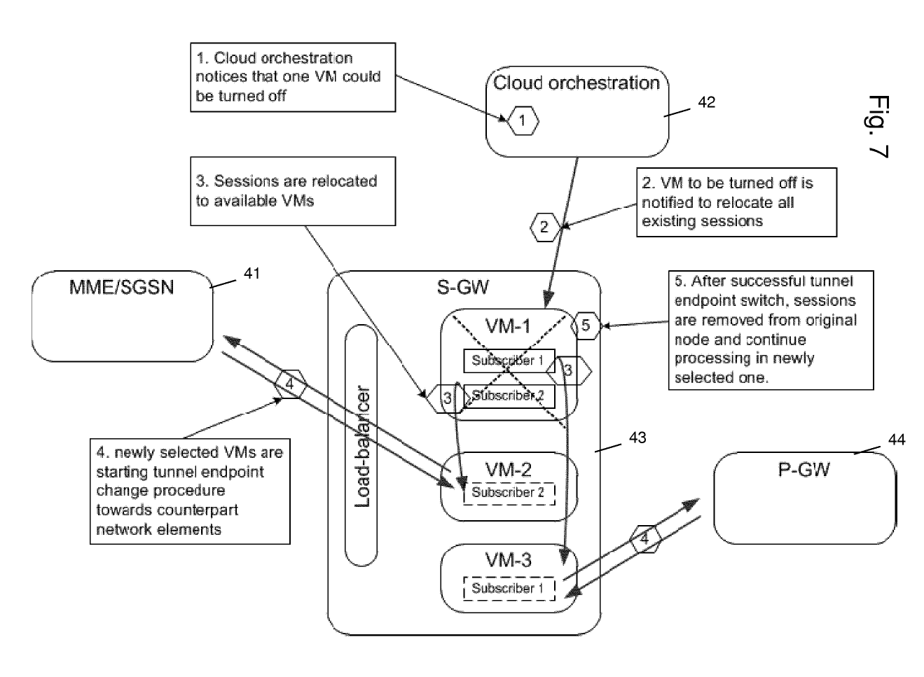

FIG. 7 is an example figure about subscriber/session relocation due to cloud optimization. In particular, FIG. 7 illustrates the possibility to relocate existing sessions to other resource by changing the TEID and tunnel IP address for active subscriber/session/bearer according to an exemplary embodiment of the present invention.

In FIG. 7, a MME (or SGSN 41), a cloud orchestration means 42, a Serving Gateway S-GW 43 and a Packet Data Network Gateway P-GW 44 are depicted. In the S-GW, a plurality of Virtual Machines VM-1 to VM-3 as well as a load balancer is provided. At first, the cloud orchestration means 42 notices that one Virtual Machine could be turned off (hexagon 1). Then, the Virtual Machine to be turned off is notified to relocate all existing sessions (hexagon 2). In response, the respective sessions are relocated to available Virtual Machines (hexagons 3). After that, the newly selected Virtual Machines are starting a tunnel endpoint change procedure towards counterpart network elements, such as SGSN, P-GW (hexagons 4). Finally, after successful tunnel endpoint switch, sessions (e.g. Subscriber 1, Subscriber 2) are removed from original node (here: VM-1), and continue processing in newly selected one (here: VM-2 and VM-2, respectively) (hexagon 5).

Besides, the main difference between MME and SGSN may be that the MME does not have bearers attached to it, which requires additional synchronisation for session and bearer transfer at the MME between eNB and SGW.

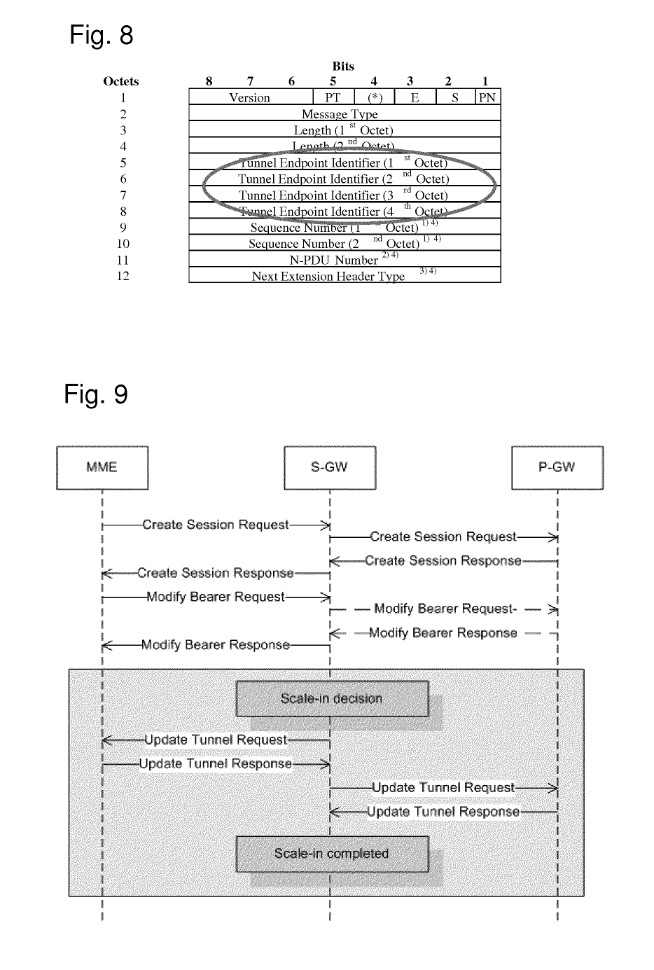

FIG. 8 illustrates the GTP header defining the tunnel endpoint which is used for identifying subscriber/session/bearer and the used hardware instance. As is indicated in FIG. 8, the TEID (1^{st} Octet to 4^{th} Octet) is located in Octet 5 to 8 of the GTP-U header.

The present invention provides the possibility to change control plane and user plane TEID, as well as possibly the tunnel IP address, for any GTP peer, e.g. for S-GW (towards MME and eNB, S4-SGSN or P-GW) and for P-GW (towards S-GW). However, it is to be noted that even this specification concentrates mainly to the gateway products, according to certain embodiments of the invention the same concept may be applied for changing the tunnel endpoints in e.g. MME, S4-SGSN, SGSN, RNC and eNB.

In order to allow the network operator to change the FTEID of the user plane at any time (i.e. not only during the TAU/RAU procedure) a specific procedure is provided to support change even during user/signaling activity. Furthermore with this procedure the session request ensuring the in sequence delivery for the control plane is supported. That is, the preservation of payload and signaling traffic is ensured even during and after the process of session transfer.

It is to be noted that, according to certain embodiments, the session transfer procedure may be independently activated for either the user plane or the control plane or both.

As regards the control plane, it is to be noted that whenever an GTP-C entity forwards the new ‘Update Tunnel request’ message towards the peer, in the meantime the peer will send possible GTP-C message towards the old GTP-C entity, and of course only after some time the peer will be able to forward future GTP-C message to the new GTP-C entity instance as indicated by the ‘Update Tunnel request’.

Likewise, as regards the user plane, it is to be noted that whenever the GTP-C entity forwards the new ‘Update Tunnel request’ message towards the peer, in the meantime the peer will send possible GTP-U packets towards the old GTP-U entity (instance), and of course only after some time the peer will be able to forward future GTP-U packets to the new GTP-U entity as indicated by the ‘Update Tunnel request’. In order to ensure continuity it is suggested to either introduce additional information element(s) to the new GTP-C message ‘Update Tunnel response” indicating when the remote peer stops the sending of the user plane exchange to the old entity and when it starts/continues the sending of the user plane exchange to the new entity or to make use of the ‘end marker’ message.

According to certain embodiments of the present invention, in case of glare/contention/crossing over of signaling messages from the remote side prioritization should for instance be given to a handover procedure in order not to degrade user experience simply because the operator decided to perform a session transfer. For that it is suggested that the peer can reject the request for the session transfer by returning back rejection indication possibly carrying a time period after which the session transfer can be performed.

Additionally, according to certain embodiments, in case of glare/contention/crossing over of signaling messages requesting a session transfer from both sides simultaneously a resolution is suggested, where the session transfer is retried at a later point of time.

According to further embodiments, the session transfer rate is controlled by the old entity to avoid network overload caused by multiple session transfers at the same time. Session transfer rate can be controlled by using predefined or random timeout between ‘Update Tunnel requests’ or by maintaining transmission window per counterpart network element. The session transfer rate can be higher for idle sessions as they do not cause as much load for surrounding network.

The benefits of the possibility to change the TEID value for existing sessions enable re-balancing functionality in the gateway. E.g. sessions could be moved from loaded (hardware) resources to (hardware) resources running on low load. By being able to change the TEID value, the system internal load balancing could remain unchanged and unfragmented (using TEID ranges) and therefore only few entries would be needed in the system internal load balancing (as opposite to host entries needed in case TEID would need to remain unchanged when moving sessions within a system). Additionally, this would enable to move sessions inside a gateway to empty certain resources for e.g. in-service-software-upgrade purposes.

The possibility to change the TEID value also facilitates to implement scale-in functionality in gateway running in a cloud. I.e. sessions on certain virtual machines could be moved to other virtual machines after which, the virtual machines could be terminated and freed for use with other applications.

In the following, changes required in GTPv2 specification according to 3GPP (3GPP 29.274) are described.

As already indicated above, according to certain embodiments of the invention a new message pair (Update Tunnel Request and Update Tunnel Response) between GTP peer elements is added. The Update Tunnel request message is preferably utilized for Idle sessions, but it is not excluded to make use of the Update Tunnel request message for non Idle sessions. Preferably the existing message are also augmented for non Idle session such that the session transfer procedure can take advantage of GTP-C message (like Modify/Update Bearer Request/Response messages) already sent due to other needs can carry the new information elements.

FIG. 9 shows a S-GW scale-in example sequence flow with session establishment and proposed new signaling according to certain embodiments. In particular, FIG. 9 illustrates an S-GW internal load balancing or scale-in with proposed solution and related messaging between S-GW and MME/SGSN and between P-GW and S-GW. Upon transmitting a ‘Create Session Request’ message from the MME to the P-GW via the S-GW, a respective response message is returned. Then, a ‘Modify Bearer Request’ message is transmitted from the MME to the P-GW via the S-GW, and a respective response message is returned. After the scale-in decision is made, the S-GW transmits a ‘Update Tunnel Request’ message to the MME, and the MME returns an ‘Update Tunnel Response’ message to the S-GW. Then, the S-GW transmits an ‘Update Tunnel Request’ message to the P-GW, and the P-GW returns an ‘Update Tunnel Response’ message to the S-GW. Then, the scale-in is completed.

A new message definition in regard to current 3GPP standards in view to the GTPv2 ‘Update Tunnel Request’ according to certain embodiments of the present invention is as follows. The direction of this message shall be from S-GW towards MME/S4-SGSN and from S-GW towards P-GW in this example. Update Tunnel Request shall be sent on the S11/S4/S5/S8 interface as a part of user plane and/or control plane F-TEID change. In S11/S4 interface single Update Tunnel Request message can update the whole subscriber information whereas in S5/S8 interface single Update Tunnel Request can update one session (PDN connection) and related bearers. S-GW needs to deliver changed P-GW F-TEID information to MME/S4-SGSN to be used in future S-GW relocation.

The following table 1 shows the Information Elements in a Update Tunnel Request according to certain embodiments:

| | | | | |
|---|---|---|---|---|
| Sender | C | Sender shall include this | F-TEID | 0 |
| F-TEID for | | IE if control plane | | |
| Control | | F-TEID has changed | | |
| Plane | | | | |
| PGW | C | The PGW shall include this | F-TEID | 1 |
| F-TEID | | IE on the S5/S8 if S5/S8 | | |
| | | F-TEID has changed. | | |
| | | If the SGW receives this | | |
| | | IE it shall forward the IE to | | |
| | | MME/S4-SGSN on S11/S4 interface. | | |
| Bearer | C | Several IEs with the same type | Bearer | 0 |
| Contexts | | and instance value may be included | Context | |
| to be | | on the S4/S11 and S5/S8 interfaces | | |
| | | as necessary to represent a list | | |
| | | of Bearers. | | |

The following table 2 shows the Bearer Context to be modified within Update Tunnel Request, Modify Bearer Request and Update Bearer Request according to certain embodiments:

| | |
|---|---|
| Octets 1 | Bearer Context IE Type = 93 (decimal) |
| Octets 2 and 3 | Length = n |
| Octets 4 | Spare and Instance fields |

| Infor- | | | | |
|---|---|---|---|---|
| mation | | | | |
| elements | P | Condition/Comment | IE Type | Ins. |
| EPS | M | | EBI | 0 |
| Bearer ID | | | | |
| S1-U SGW | C | This IE shall be included on | F-TEID | 0 |
| F-TEID | | the S11 interface if the | | |
| | | S1-U F-TEID is modified. | | |
| S4-U SGW | C | This IE shall be included on | F-TEID | 1 |
| F-TEID | | the S4 interface if the | | |
| | | S4-U F-TEID is modified. | | |
| S5/S8-U | C | This IE shall be included on | F-TEID | 2 |
| PGW F-TEID | | the S5/S8 interface if the | | |
| | | S5/S8-U F-TEID is modified. | | |
| | | This IE shall be included on | | |
| | | the S11/S4 interface if | | |
| | | P-GW has modified | | |
| | | F-TEID for user plane. | | |
| S12 SGW | C | This IE shall be included on | F-TEID | 3 |
| F-TEID | | the S4 interface if the | | |
| | | S12 F-TEID is modified. | | |

The following table 2a shows Information Elements added to the Modify Bearer Request and Update Bearer Request according to certain embodiments:

| | | | | |
|---|---|---|---|---|
| Sender | C | Sender shall include this IE if | F-TEID | 0 |
| F-TEID for | | control plane F-TEID has | | |
| Control | | changed | | |
| Plane | | | | |
| PGW | C | The PGW shall include this | F-TEID | 1 |
| F-TEID | | IE on the S5/S8 if S5/S8 | | |
| | | F-TEID has changed. | | |
| | | If the SGW receives this | | |
| | | IE it shall forward the IE to | | |
| | | MME/S4-SGSN on S11/S4 interface. | | |

Here, it is to be noted that the Bearer Context to be modified within Modify Bearer and Update bearer is the same as depicted in table 2.

A new message definition in regard to current 3GPP standards in view to the GTPv2 ‘Update Tunnel Response’ according to certain embodiments of the present invention is as follows. The direction of this message shall be from MME/S4-SGSN towards S-GW and from S-GW towards P-GW in this example. Update Tunnel Response shall be sent on the S11/S4/S5/S8 interface as a response to Update Tunnel Request as part of user plane and/or control plane F-TEID change.

The following table 3 shows Information Elements in an Update Tunnel Response, Modify Bearer Response and Update Bearer Response according to certain embodiments:

| Infor- | | | | |
|---|---|---|---|---|
| mation | | | | |
| elements | P | Condition/Comment | IE Type | Ins. |
| Cause | M | | Cause | 0 |
| Bearer | C | This IE shall contain bearer contexts | Bearer | 0 |
| Contexts | | related to bearers for which F-TEID | Context | |
| | | modification was requested. Several | | |
| | | IEs with this type and instance | | |
| | | values shall be included as necessary | | |
| | | to represent a list of Bearers | | |
| “GTP-C | C | This IE shall contain the value | | |
| transfer | | of the sequence number of the | | |
| sequence | | GTP-C message which will be sent | | |
| number” | | to the new e.g. SGW instance | | |

The following table 4 shows Bearer Context to be modified within Update Tunnel Response according to certain embodiments:

| | |
|---|---|
| Octet 1 | Bearer Context IE Type = 93 (decimal) |
| Octets 2 and 3 | Length = n |
| Octet 4 | Spare and Instance fields |

| Infor- | | | | |
|---|---|---|---|---|
| mation | | | | |
| elements | P | Condition/Comment | IE Type | Ins. |
| EPS | M | | EBI | 0 |
| Bearer ID | | | | |
| Cause | M | This IE Indicates if the bearer | Cause | 0 |
| | | handling was successful, and if not, | | |
| | | gives information on the reason. | | |
| “GTP-U | C | This IE shall contain the value | | |
| transfer | | of the sequence number of the | | |
| sequence | | GTP-U message which will be sent | | |
| number” | | to the e.g. new SGW instance | | |

The following table 4a shows Information Elements added to the Modify Bearer Response and Update Bearer Response according to certain embodiments:

| Infor- | | | | |
|---|---|---|---|---|
| mation | | | | |
| elements | P | Condition/Comment | IE Type | Ins. |
| “GTP-C | C | This IE shall contain the value | | |
| transfer | | of the sequence number of the | | |
| sequence | | GTP-C message which will be sent | | |
| number” | | to the e.g. new SGW instance | | |

It is to be noted that the Bearer Context to be modified within Modify Bearer Response and Update bearer Response is the same as depicted in table 4.

Further, it is to be noted that similar changes which are needed for TS 29274 are in principle also needed for 3GPP TS 36.413 (S1-MME Interface).

The GTP-U Transfer sequence number is coded as depicted in the following table 4b. The GTP-U Sequence number itself is defined in the 3GPP TS 29281:

Bits

| | | | | | | | | |
|---|---|---|---|---|---|---|---|---|
| Octets | 8 | 7 | 6 | 5 | 4 | 3 | 2 | 1 |

| | |
|---|---|
| 1 | Type = yy (decimal) |
| 2 to 3 | Length = 2 |
| 4 | Sequence Number (1^{st} Octet) |
| 5 | Sequence Number (2^{na} Octet) |

In the following, changes required in GTPv1 specification (3GPP 29.060) according to certain embodiments of the present invention are shown.

As regards the GTPv1 Update Tunnel Request, according to certain embodiments the direction of this message shall be from GGSN/P-GW towards Pre-Rel8-SGSN. The Update Tunnel Request shall be sent on the Gn/Gp interface as a part of user plane and/or control plane TEID change.

The following table 5 shows Information Elements in a GGSN-Initiated Update Tunnel Request according to certain embodiments:

| | Presence | |
|---|---|---|
| Information element | requirement | Reference |
| NSAPI | Mandatory | 7.7.17 |
| Tunnel Endpoint Identifier Data I | Conditional | 7.7.13 |
| Tunnel Endpoint Identifier Control Plane | Conditional | 7.7.14 |
| GGSN Address for Control Plane | Conditional | GSN Address |
| | | 7.7.32 |
| GGSN Address for user traffic | Conditional | GSN Address |
| | | 7.7.32 |

As regards the GTPv1 Update Tunnel Response, according to certain embodiments, the direction of this message shall be from Pre-Rel8-SGSN towards GGSN/P-GW. The Update Tunnel Response shall be sent on the Gn/Gp interface as a response to Update Tunnel Request as part of user plane and/or control plane TEID change.

In view of the GTP control plane, it is to be noted that whenever a SGW-C forwards the new ‘Update Tunnel request’ message towards the peer, in the meantime the peer will send possible GTP-C message towards the old SGW (instance), and of course only after some time the peer will be able to forward the future GTP-C message to the new SGW instance as indicated by the ‘Update Tunnel request’.

In order to ensure continuity, according to certain embodiments the following is suggested.

As regards the MME, on receipt of the ‘Update Tunnel request’ message the receiver takes over the new FTEID for the Control plane and responds with a ‘Update Tunnel response’ message. For example, the receiver of the ‘Update Tunnel request’” message will continue to send GTP-C messages to the old VM until the ‘Update Tunnel response’ was sent. After the ‘Update Tunnel response’ was sent, the peer shall send subsequent messages to the new SGW instance as requested in the ‘Update Tunnel request’ message.

If in the ‘Update Tunnel request’ also a session transfer for the user plane is requested, the ‘Update Tunnel request’ is forwarded to the eNB, and the ‘Update Tunnel response’ is to be postponed until the receipt of the ‘Update Tunnel response’ from the eNB.

As regards the Old SGW-C, according to certain embodiments, until receipt of the ‘Update Tunnel response’ at the old SGW-C, the requesting (old) SGW-C instance will forward any GTP-C message to the new SGW-C. The ‘Update Tunnel response’ is not sent from the old SGW-C to the new SGW-C as according to this procedure, and the peer will sent any subsequent messages after the ‘Update Tunnel response’ to the new SGW-C.

As regards the new SGW-C, according to this procedure in line with certain embodiments the new SGW-C will receive the subsequent messages from the peer after the ‘Update Tunnel response’ message.

This procedure is needed in order to be able to synchronize GTP-C messages being received from two different sources.

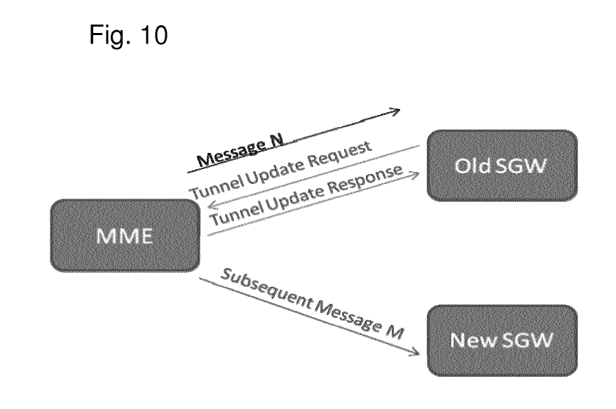

The above session transfer synchronization (control plane) according to certain embodiments of the present invention is schematically shown in FIG. 10.

In view of the GTP User plane, it is to be noted that whenever the SGW-C forwards the new ‘Update Tunnel request’ message towards the peer, in the meantime the peer will send possible GTP-U packets towards the old SGW (instance), and of course only after some time the peer will be able to forward future the GTP-U packets to the new SGW instance as indicated by the ‘Update Tunnel request’. In order to ensure continuity, according to certain embodiments the following is suggested.

According to certain embodiments, there are two options provided for performing the session/bearer transfer. That is, on the one hand, making use of the sequence number capability of GTP-U packets, and, on the other hand, without relying on in sequence delivery.

In particular, the following options are provided according to certain embodiments: Option a) (In sequence delivery). In general GTP-U allows for in sequence delivery via the Sequence Number carried in the GTP-U header. Within this option the transmission order of GTP-U packets is preserved. Option b) (without in sequence delivery). Within this option the transmission order of GTP-U packets is not preserved.

As regards Option a), and particularly the eNB, on receipt of the ‘Update Tunnel request’ message the receiver takes over the new FTEID for the User plane and responds with a ‘Update Tunnel response’ message inserting additionally a new optional ‘GTP-U transfer sequence number’ parameter to carry the value of the sequence number, of that GTP-U message which will be sent to the new SGW-U instance as indicated in the ‘Update Tunnel request’ message. For example, the receiver of the ‘Update Tunnel request’ message will continue to send GTP-U messages to the old VM as long as the normal/already standardized GTP-U sequence number does not equal the value of ‘GTP-U transfer sequence number’ parameter sent in the response. When it would equal the peer shall send it to the new SGW-U instance as requested in the ‘Update Tunnel request’ message.

In view of Option a) and particularly the old SGW-U, the requesting (old) SGW-U instance on/in the old VM/load balancer will forward any GTP-U packet to the new SGW-U as long as the GTP-U packet does not equal the value in the ‘GTP-U transfer sequence number’ parameter as received in the ‘Update Tunnel response’ message. In case it is equal or higher the load balancer/old SGW-U suppresses the sending of the GTP-U messages to the new instance. The old SGW-U inserts the ‘GTP-U transfer sequence number’ parameter additionally into the first GTP-U packet/message sent to the new instance.

Alternatively the ‘GTP-U transfer sequence number’ parameter may also be carried in the/a GTP-C message, however it might not be that advantageous, since the information needs to be sent from the User plane to the local Control plane and via the Control plane signaling to the adjacent control plane signaling, and from there to the corresponding user plane again. Probably it is most efficient to keep the user plane information on the user plane instead to where it natively belongs.

In view of Option a) and particularly the new SGW-U, since the new SGW-U will receive the first GTP-U packets from the old instance, the new SGW-U stores the value of the ‘transfer GTP sequence number’ parameter.

As such then the new SGW-U evaluates the GTP-U packet being received from the old SGW-C or the eNB directly. If the ‘sequence number’ received via the interface from the old SGW is lower than the ‘transfer GTP sequence number’ parameter, the new SGW-U acts on upon the GTP-U packet, otherwise it ignores it. If the ‘sequence number’ received via the interface from the eNB is equal or higher than the ‘transfer GTP sequence number’ parameter, the new SGW-U acts on upon the GTP-U packet, otherwise it ignores it.

This procedure is needed in order to be able to synchronize in sequence delivery of GTP-U packets being received from two different sources. Possibly the load balance or new software part of the SGW-U would be enhanced accordingly to detect and ensure this.

In case of glare/contention/crossing over of signaling messages from the remote side prioritization should for instance be given to a handover procedure in order not to degrade user experience simply because the operator decided to perform a session transfer.

It is to be noted that the above description is only one example of a number of use cases and it is therefore not limiting, because any other node may it the eNB, the MME or the PGW may initiate the session transfer.

Furthermore in the above example only one direction of signaling and user plane transmission is described e.g. from the MME/eNB towards the old/new SGW, but the opposite direction, in general, is performed in the similar way.

The Option a) relies on the following assumptions. Firstly, the peer sends packets to old until it switches to new one. Further, all packets are sent in order and delivery between the different peers are preserving the order. Still further, new one is buffering all packets until last packet is received from old (notified e.g. with end marker). New one uses the source address to differentiate peer and old one. Moreover, new one is forwarding all packets from old one and when the last packet is received it forwards all buffered packets and starts acting in normal mode.

Furthermore, as regards Option b) (without in sequence delivery), and particularly the eNB, on receipt of the ‘Update Tunnel request’ message the receiver takes over the new FTEID for the User plane and responds with a ‘Update Tunnel response’ message, may send some GTP-U packets towards the old VM and starts sending GTP-U towards the new VM while simultaneously sending one or more End marker messages towards the old VM

Furthermore, as regards Option b) and particularly the old SGW-U, the requesting (old) SGW-U instance on/in the old VM/load balancer will forward any GTP-U packet to the new SGW-U. Once the ‘end marker’ is received the Old SGW-U does not forward the packets to the new SGW-U.

Furthermore, as regards Option b) and particularly the new SGW-U, the new SGW needs to buffer messages until it receives the indication from old SGW-U instance that all PDUs are delivered (End Marker). Then the new SGW-U instance may forward any buffered packets from eNB.

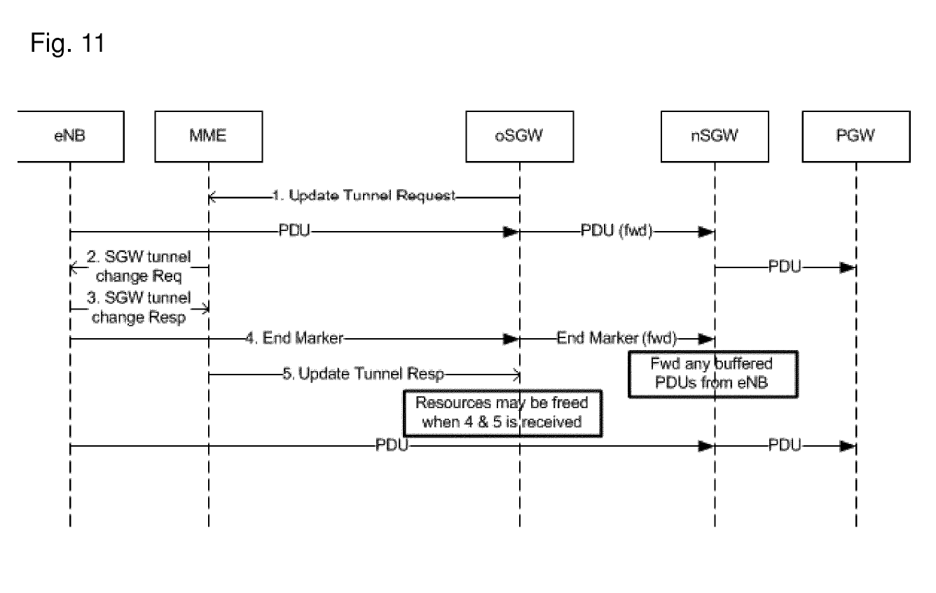

FIG. 11 shows such session transfer synchronization (user plane) according to certain embodiments of the present invention.

In case of glare/contention/crossing over of signaling messages from the remote side prioritization should for instance be given to a handover procedure in order not to degrade user experience simply because the operator decided to perform a session transfer.

In case an entity has sent a ‘Tunnel Update request’ for a bearer and no ‘Tunnel Update response’ had been received, but a ‘Tunnel Update request’ from its peer, then the entity which allocated the ‘EPS Bearer ID’ for the bearer in question shall start a Timer M and the whereas the other entity shall start a Timer N. M has a randomly chosen value between e.g. 2.1 and 4 seconds, and M has a randomly chosen value between e.g. 0.7 and 1.8 seconds. After the expiry of the M or N respectively the ‘Tunnel Update request’ is sent again (if e.g. the bearer still exists).

In case an entity has sent a ‘Tunnel Update request’ for a (Call Control) session and no ‘Tunnel Update response’ had been received, but a ‘Tunnel Update request’ from its peer, then the entity with the higher value of Sender TEID for the Control Plane a Timer M and the whereas the other entity shall start a Timer N. M has a randomly chosen value between e.g. 2.1 and 4 seconds, and M has a randomly chosen value between e.g. 0.7 and 1.8 seconds. After the expiry of the M or N respectively the ‘Tunnel Update request’ is sent again (if e.g. the session still exists).

It is to be noted that the above description is only one example of a number of use cases and it is therefore not limiting, because any other node may be the eNB, the MME or the PGW may initiate the session transfer.

Furthermore in the above example only one direction of signaling and user plane transmission is described e.g. from the MME/eNB towards the old/new SGW, but the opposite direction, in general, is performed in the similar way.

Moreover, it is admitted that if for a particular reason, which is considered to be very seldom, information like the ‘End marker message’ may be lost, the session transfer cannot be completed. Therefore, according to certain embodiments, a supervision timer is introduced, which is started when the ‘update tunnel request’ message had been sent, with a value greater or about the value of two *T3-RESPONSE *N3-REQUESTS, which supervises the successful completion of the session transfer.

When this timer expires, the session transfer procedure is considered to have failed and the resources are released.

It is to be noted that embodiments of the present invention may be implemented as circuitry, in software, hardware, application logic or a combination of software, hardware and application logic. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer or smart phone, or user equipment.

As used in this application, the term “circuitry” refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present. This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

The present invention relates in particular but without limitation to mobile communications, for example to environments under LTE™ or LTE-Advanced, and can advantageously be implemented also in controllers, base stations, user equipments or smart phones, or computers connectable to such networks. That is, it can be implemented e.g. as/in chipsets to connected devices.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The communication network is also able to communicate with other networks, such as a public switched telephone network or the Internet. The communication network may also be able to support the usage of cloud services. It should be appreciated that BSs and/or eNBs or their functionalities may be implemented by using any node, host, server or access node etc. entity suitable for such a usage.

Furthermore, the described network elements, such as terminal devices or user devices like UEs, communication network control elements of a cell, like a BS or an eNB, access network elements like APs and the like, as well as corresponding functions as described herein may be implemented by software, e.g. by a computer program product for a computer, and/or by hardware. In any case, for executing their respective functions, correspondingly used devices, nodes or network elements may comprise several means, modules, units, components, etc. (not shown) which are required for control, processing and/or communication/signaling functionality. Such means, modules, units and components may comprise, for example, one or more processors or processor units including one or more processing portions for executing instructions and/or programs and/or for processing data, storage or memory units or means for storing instructions, programs and/or data, for serving as a work area of the processor or processing portion and the like (e.g. ROM, RAM, EEPROM, and the like), input or interface means for inputting data and instructions by software (e.g. floppy disc, CD-ROM, EEPROM, and the like), a user interface for providing monitor and manipulation possibilities to a user (e.g. a screen, a keyboard and the like), other interface or means for establishing links and/or connections under the control of the processor unit or portion (e.g. wired and wireless interface means, radio interface means comprising e.g. an antenna unit or the like, means for forming a radio communication part etc.) and the like, wherein respective means forming an interface, such as a radio communication part, can be also located on a remote site (e.g. a radio head or a radio station etc.). It is to be noted that in the present specification processing portions should not be only considered to represent physical portions of one or more processors, but may also be considered as a logical division of the referred processing tasks performed by one or more processors.

The following meanings for the abbreviations used in this specification apply:
CP Control Plane
FTEID Fully qualified TEID
GGSN Gateway GPRS Support Node
G-PDU GTP-U non-signalling PDU
GTP GPRS Tunnelling Protocol
GTP-PDU GTP-C PDU or GTP-U PDU
GW Gateway
LTE Long Term Evolution
MME Mobility Management Entity
MT Mobile Terminal
PGW Packet Data Network Gateway
RAU Routing Area Update
SAE System Architecture Evolution
SDN Software Defined Network
SGW Serving Gateway
SGSN Serving GSN Support Node
SGW-C SGW Control plane
SGW-U SGW User plane
TAU Tracking Area Update
UE User Equipment
UP User Plane
TEID Tunnel Endpoint Identifier

1. Method for relocating an existing session in a communication system from an original resource to another resource, comprising:
allocating a new Tunnel Endpoint Identifier value for the existing session;
communicating information about relocating the existing session including the new Tunnel Endpoint Identifier value for the existing session to the peer network elements of the original resource;
performing tunnel endpoint change procedure towards counterpart network elements; and
removing the existing session from original resource and continuing processing in the another resource.

2. The method according to claim 1, further comprising allocating a new tunnel IP-address for the existing session, and adding the new tunnel IP-address to the information.

3. (canceled)

4. The method according to claim 1, wherein the session transfer procedure is independently activated for either the user plane or the control plane or both.

5. The method according to claim 1, wherein one or plural of the original and the another resources are realized as at least one of Virtual Machines, hardware resource and physical server.

6. The method according to claim 1, wherein, in case of any of glare, contention and crossing over of signaling messages, the peer rejects the request for session relocation by returning back a rejection indication.

7. The method according to claim 6, wherein the indication comprises a time period after which the session relocation can be performed.

8. (canceled)

9. The method according to claim 1, wherein the session relocation rate is controlled by the original resource.

10.-12. (canceled)

13. The method according to claim 1, wherein the peer network elements are from the group comprising Mobility Management Entity, Serving GSN Support Node, Packet Data Network Gateway and Serving Gateway, Gateway GPRS Support Node, Radio Network Controller, evolved NodeB and Home eNB.

14. The method according to claim 1, wherein in sequence delivery via the Sequence Number carried in a GTP-U header for preserving the transmission order of packets is performed.

15. The method according to claim 1, wherein the original resource buffers messages until it receives an End Marker from the another resource indicating that all Protocol Data Units are delivered.

16. Apparatus for relocating an existing session in a communication system from an original resource to another resource, comprising:
an allocation unit configured to allocate a new Tunnel Endpoint Identifier value for the existing session;
a communication unit configured to cause a communication of information about relocating the existing session including the new Tunnel Endpoint Identifier value for the existing session to the peer network elements of the original resource being relocated;
a changing unit configured to perform a tunnel endpoint change procedure towards counterpart network elements; and
a processing unit configured to remove the existing session from original resource and to continue processing in the another resource.

17. The apparatus according to claim 16, the allocation unit is further configured to allocate a new tunnel IP-address for the existing session, and to add the new tunnel IP-address to the information.

18. (canceled)

19. The apparatus according to claim 16, wherein the session transfer procedure is independently activated for either the user plane or the control plane or both.

20. The apparatus according to claim 16, wherein one or plural of the original and the another resources are realized as at least one of Virtual Machines, hardware resource and physical server.

21. The apparatus according to claim 16, wherein, in case of any of glare, contention and crossing over of signaling messages, the peer is configured to reject the request for session relocation by returning back a rejection indication.

22. The apparatus according to claim 21, wherein the indication comprises a time period after which the session relocation can be performed.

23. (canceled)

24. The apparatus according to claim 16, wherein the session relocation rate is controlled by the original resource.

25.-27. (canceled)

28. The apparatus according to claim 16, wherein the peer network elements are from the group comprising Mobility Management Unit, Serving GSN Support Node, Packet Data Network Gateway and Serving Gateway, Gateway GPRS Support Node, Radio Network Controller, evolved NodeB and Home eNB.

29. The apparatus according to claim 16, further configured to perform in sequence delivery via the Sequence Number carried in a GTP-U header for preserving the transmission order of packets.

30. The apparatus according to claim 16, wherein the original resource is configured to buffer messages until it receives an End Marker from the another resource indicating that all Protocol Data Units are delivered.

31. A computer program product embodied on a non-transitory computer-readable medium, said product including software code portions for performing the steps of claim 1 when said product is run on the computer.

32. (canceled)

33. (canceled)
